(19) United States
(12) Patent Application Publication
(10) Pub. No.: US 2014/0118925 A1
(43) Pub. Date: May 1, 2014

(54) COMPUTING DEVICE AND METHOD FOR CONTROLLING TEMPERATURE OF PROCESSOR OF THE COMPUTING DEVICE

(71) Applicant: HON HAI PRECISION INDUSTRY CO., LTD., New Taipei (TW)

(72) Inventor: YU-CHEN HUANG, New Taipei (TW)

(73) Assignee: HON HAI PRECISION INDUSTRY CO., LTD., New Taipei (TW)

(21) Appl. No.: 14/029,870

(22) Filed: Sep. 18, 2013

(30) Foreign Application Priority Data
Oct. 30, 2012 (TW) 101140204

(51) Int. Cl. G06F 1/20

(52) U.S. Cl. CPC G06F 1/206
USPC 361/679.48

(57) ABSTRACT

In a method for controlling a temperature of a processor of a computing device, an association between power consumptions of the processor and rotational speeds of an electric fan coupled to the processor is established. A real-time power consumption of the processor is measured, and a work mode of the processor is determined. If the processor is in a turbo mode, a rotational speed of the electric fan corresponding to the real-time power consumption of the processor is determined. The electric fan is controlled to rotate at the determined rotational speed.

### BACKGROUND

1. Technical Field

The embodiments of the present disclosure relate to temperature controlling systems and methods, and particularly to a computing device and a method for controlling a temperature of a processor of the computing device.

2. Description of Related Art

A processor of a computing device can work in a turbo mode. In the turbo mode, a temperature of the processor rises quickly. Overheating of the processor can lead to instability of the computing device and damage to the processor. Currently, temperature sensors and electric fans are coupled to the processor for heat dissipation. The temperature sensors measure the temperature of the processor, while the electric fans are controlled to rotate at different rotational speeds. However, with current temperature controlling methods, the temperature of the processor cannot be adjusted quickly. Sometimes the processor has to exit from the turbo mode due to overheating. Therefore, there is room for improvement in the art.

### BRIEF DESCRIPTION OF THE DRAWINGS

FIG. 1 is one embodiment of a computing device including a temperature controlling system.

FIG. 2 is a block diagram of one embodiment of function modules of the temperature controlling system of the computing device of FIG. 1.

FIG. 3 is a flowchart of one embodiment of a method for controlling a temperature of a processor of the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, JAVA, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

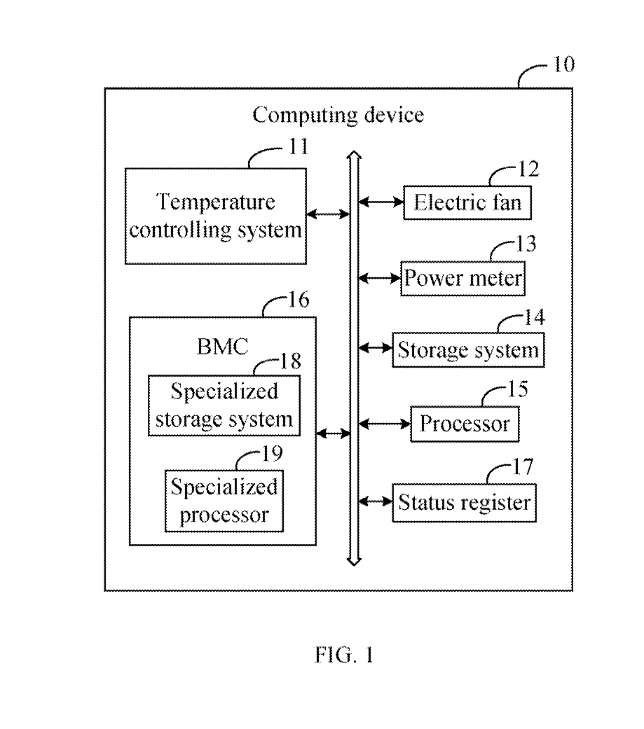

FIG. 1 is one embodiment of a computing device 10 including a temperature controlling system 11. The computing device 10 further includes at least one electric fan 12 (only one shown in FIG. 1), a power meter 13, a storage system 14, a processor 15, a baseboard management controller (BMC) 16, and a status register 17. The BMC 16 includes a specialized storage system 18 and a specialized processor 19. The power meter 13 is coupled to the processor 15 and measures power consumption of the processor 15. The temperature controlling system 11 controls rotational speeds of the electric fan 12 according to the power consumption of the processor to keep the processor 15 within a predetermined temperature range.

The storage system 14 may be a dedicated memory, such as an EPROM, a hard disk drive (HDD), or flash memory. In some embodiments, the storage system 14 may also be an external storage device, such as an external hard disk, a storage card, or other data storage medium.

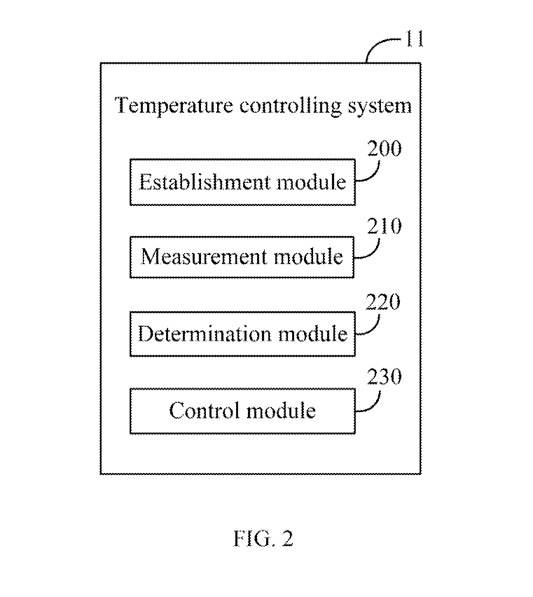

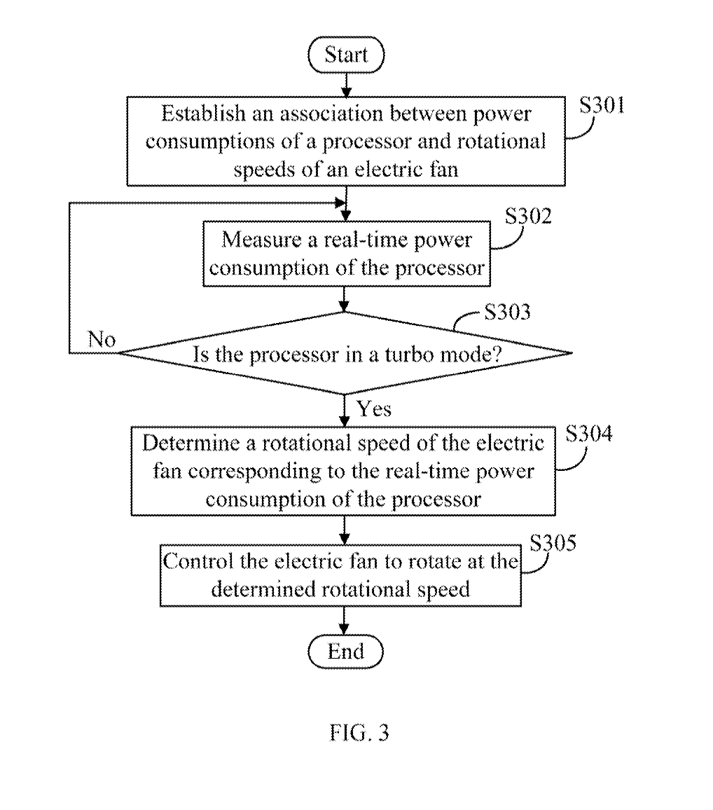

FIG. 2 is a block diagram of one embodiment of function modules of the temperature controlling system 11 of FIG. 1. The temperature controlling system 11 includes an establishment module 200, a measurement module 210, a determination module 220, and a control module 230. The modules 200-230 may comprise computerized code in the form of one or more programs that are stored in the storage system 14. The computerized code includes instructions that are executed by the processor 15 to provide the aforementioned functions of the temperature controlling system 11. In this embodiment, the computing device 10 includes the BMC 16. The computerized code of the temperature controlling system 11 may be stored in the specialized storage system 18 of the BMC 16 and executed by the specialized processor 19 of the BMC 16. A detailed description of the functions of the modules 200-230 is given below in reference to FIG. 3.

FIG. 3 is a flowchart of one embodiment of a method for controlling a temperature of the processor of the computing device in FIG. 1. Depending on the embodiment, additional steps may be added, others removed, and the ordering of the steps may be changed.

In step S301, the establishment module 200 establishes an association between power consumptions of the processor 15 and rotational speeds of the electric fan 12, and stores the association in the storage system 14. According to the association, a rotational speed of the electric fan 12 corresponding to a given power consumption (or a given power consumption range) of the processor 15 is determined For example, if a power consumption of the processor 15 is 120 watts (or between 110 watts and 130 watts), a corresponding rotational speed of the electric fan 12 is 10000 revolutions per minute (RPM). If a power consumption of the processor 15 is 130 watts (or between 120 watts and 140 watts), a corresponding rotational speed of the electric fan 12 is 12000 RPM.

In step S302, the measurement module 210 controls the power meter 13 to measure a real-time power consumption of the processor 15. The measurement module 210 measures the real-time power consumption of the processor 15 at a predetermined time frequency, such as once every ten seconds, for example.

In step S303, the determination module 220 determines whether or not the processor 15 is in a turbo mode. If the processor is in the turbo mode, the process goes to step S304. If the processor 15 is not in the turbo mode, the process returns to step S302. In this embodiment, the computing device 10 includes the status register 17. The determination module 220 reads a value of the status register 17 and determines whether or not the processor 15 is in the turbo mode according to the value of the status register 17. For example, the status register 17 includes a work mode flag. If the work mode flag is equal to a first value (e.g., 1), the determination module 220 determines that the processor 15 is in the turbo mode. If the work mode flag is equal to a second value (e.g., 0), the determination module 220 determines that the processor 15 is not in the turbo mode.

In step S304, if the processor 15 is in the turbo mode, the determination module 220 determines a rotational speed of the electric fan 12 corresponding to the real-time power consumption of the processor 15 according to the association between the power consumptions of the processor 15 and the rotational speeds of the electric fan 12. For example, if the real-time power consumption of the processor 15 is 130 watts, the determination module 220 determines that a rotational speed of the electric fan 12 is 12000 RPM. In one embodiment, only when the processor 15 is in the turbo mode and the real-time power consumption of the processor 15 is greater than a predetermined value (e.g., 100 watts) does the determination module 220 determine the rotational speed of the electric fan 12 corresponding to the real-time power consumption of the processor 15 according to the association. If the real-time power consumption of the processor 15 is less than or equal to the predetermined value, the real-time power consumption of the processor 15 is ignored by the determination module 220.

In step S305, the control module 230 controls the electric fan 12 to rotate at the determined rotational speed. The control module 230 may generate a rotational speed control command according to the rotational speed and send the rotational speed control command to the electric fan 12. In response to the rotational speed control command, the electric fan 12 rotates at the determined rotational speed.

Changes in power consumptions of the processor 15 cause changes in the temperature of the processor 15. With the present method, the temperature of the processor 15 is adjusted quickly so that the processor 15 can work in the turbo mode stably for an extended period of time.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for controlling a temperature of a processor of a computing device being executed by the processor of the computing device, the method comprising:
establishing an association between power consumptions of the processor and rotational speeds of at least one electric fan coupled to the processor;
measuring a real-time power consumption of the processor;
determining a rotational speed of the at least one electric fan corresponding to the real-time power consumption of the processor according to the association when the processor is in a turbo mode; and
controlling the at least one electric fan to rotate at the determined rotational speed.

2. The method of claim 1, wherein the computing device comprises a status register and whether the processor is in the turbo mode is determined according to a value of the status register.

3. The method of claim 1, wherein the rotational speed of the at least one electric fan corresponding to the real-time power consumption of the processor is determined according to the association when the processor is in the turbo mode and the real-time power consumption of the processor is greater than a predetermined value.

4. The method of claim 1, wherein the method is executed by a specialized processor of a baseboard management controller of the computing device.

5. A computing device, comprising:
a processor; and
a storage system storing a plurality of instructions, which when executed by the processor, cause the processor to:
establish an association between power consumptions of the processor and rotational speeds of at least one electric fan coupled to the processor;
measure a real-time power consumption of the processor;
determine a rotational speed of the at least one electric fan corresponding to the real-time power consumption of the processor according to the association when the processor is in a turbo mode; and
control the at least one electric fan to rotate at the determined rotational speed.

6. The computing device of claim 5, wherein the computing device comprises a status register and whether the processor is in the turbo mode is determined according to a value of the status register.

7. The computing device of claim 5, wherein the rotational speed of the at least one electric fan corresponding to the real-time power consumption of the processor is determined according to the association when the processor is in the turbo mode and the real-time power consumption of the processor is greater than a predetermined value.

8. The computing device of claim 5, wherein the plurality of instructions are executed by a specialized processor of a baseboard management controller of the computing device.

9. A non-transitory computer-readable storage medium storing a set of instructions, the set of instructions capable of being executed by a processor of a computing device to implement a method for controlling a temperature of the processor of the computing device, the method comprising:
establishing an association between power consumptions of the processor and rotational speeds of at least one electric fan coupled to the processor;
measuring a real-time power consumption of the processor;
determining a rotational speed of the at least one electric fan corresponding to the real-time power consumption of the processor according to the association when the processor is in a turbo mode; and
controlling the at least one electric fan to rotate at the determined rotational speed.

10. The storage medium of claim 9, wherein the computing device comprises a status register and whether the processor is in the turbo mode is determined according to a value of the status register.

11. The storage medium of claim 9, wherein the rotational speed of the at least one electric fan corresponding to the real-time power consumption of the processor is determined according to the association when the processor is in the turbo mode and the real-time power consumption of the processor is greater than a predetermined value.

12. The storage medium of claim 9, wherein the method is executed by a specialized processor of a baseboard management controller of the computing device.
